(19) United States
(12) Patent Application Publication
(10) Pub. No.: US 2004/0202116 A1
(43) Pub. Date: Oct. 14, 2004

(54) Wireless remote-control system and method for operating said system

(76) Inventors: Heinrich Wienold, Munchen (DE); Roland Bicker, Dachau (DE); Martin Eibl, Berglern (DE); Bernhard Sbick, Berlin (DE)

Correspondence Address: Fulbright & Jaworski, 29th Floor, 865 South Figueroa, Los Angeles, CA, 90017-2571, US

(21) Appl. No.: 10/476,765

(22) PCT Filed: Mar. 24, 2003
(86) PCT No.: PCT/EP03/03053

(30) Foreign Application Priority Data
Mar. 28, 2002 (DE) 10214146.0

(51) Int. Cl. G06F 15/16; H04B 7/00

(52) U.S. Cl. 370/310; 709/227

(57) ABSTRACT

The invention relates to a radio ripple control system for the control of a plurality of decentralized customer terminals in dependence on customer-initiated transmission requests by means of central longwave transmission devices, comprising at least two central longwave transmitters operable independently of one another, at least two central units which are each associated with one of the longwave transmitters and which are designed in each case for the control of the transmission operation of at least one longwave transmitter in dependence on the customer-initiated transmission requests, a plurality of decentralized customer stations designed for the transmission of the customer-initiated transmission requests to the central units, and a plurality of decentralized radio receivers stationed in the reception region, with at least one customer terminal to be controlled being associated with each of the decentralized radio receivers, each of which is associated with at least one of the central unit in dependence on its location, with the transmission requests relating in each case to at least one radio receiver being able to be transmitted to the corresponding central unit automatically via communication connections which can be set up at the customer connections in dependence on the respective radio receiver and with radio control telegrams corresponding to the transmission requests being able to be transmitted automatically in dependence on control commands generated by means of the central units and transmitted to the longwave transmitters. The invention moreover relates to a method for the operation of such a system.

The invention relates to a radio ripple control system for the control of a plurality of decentralized customer terminals in dependence on customer-initiated transmission requests by means of central longwave transmission devices.

The invention also relates to a method for the operation of such a radio ripple control system.

The principle of the control of terminals by means of a longwave ripple control system is generally known. A plurality of customers can utilize a common longwave transmission device with this system in order to control their own terminals or the terminals of their own customers. Energy supply corporations utilize the control system for tariff and load control and for the control of lighting devices such as street lighting.

It is the object of the invention to provide a radio ripple control system as well as a method for the operation of such a system whereby a plurality of users, who make different demands on a radio ripple control system, are allowed to control any desired number of their own terminals either singly or group-wise in accordance with individual wishes, with the radio ripple control system in particular being able to be expanded in a simple manner to any desired number of users with in each case any desired number of terminals to be controlled and generally being open to everyone irrespective of their place of residence or work and irrespective of the locations of the terminals to be controlled.

This object is satisfied by the features of claim 1 relating to the radio ripple control system and in particular in that at least two central long-wave transmitters which can be operated independently of one another, at least two central units which are associated with a respective one of the longwave transmitters and which are each designed for the control of the transmission operation of at least one longwave transmitter in dependence on the customer-initiated transmission requests, a plurality of decentralized customer stations designed for the transmission of the customer-initiate transmission requests to the central units and a plurality of decentralized radio receivers stationed in the reception territory are provided, with at least one customer terminal to be controlled being associated with each of the decentralized radio receivers, each of which is associated with at least one of the central units in dependence on its location, with the transmission requests relating in each case to at least one radio receiver being able to be transmitted automatically to the corresponding central unit via communication connections which can be set up at the customer stations and with radio control telegrams corresponding to the transmission requests being able to be transmitted automatically in dependence on control commands generated by means of the control units and transmitted to the longwave transmitters.

In accordance with the invention, a decentralization is also advantageously provided of the central devices important for the operation of the radio ripple control system by the provision of at least two longwave transmitters with each of which a central unit is associated for the control of the transmission operation.

A particularly flexible organization of the radio ripple control system is hereby made possible. The individual customers or the radio receivers associated with their terminals to be controlled can be directly associated with the individual central units in accordance with an individually predeterminable organizational scheme. In particular, those radio receivers stationed in the overlapping region of the ranges of a plurality of longwave transmitters can be alternatively associated with one of the longwave transmitters.

The radio receivers are preferably only designed for the reception of one single longwave frequency.

In accordance with a particularly preferred embodiment of the invention, the radio ripple control system is designed such that the communication connections between at least some of the customer stations and the central units can be set up via the Internet.

By the inclusion of the Internet, the radio ripple control system is advantageously opened up to everyone. It is in particular made possible hereby for private households to be able to utilize the radio ripple control system with minimum investment costs and at affordable utilization costs in order, for example, to control their own domestic technical equipment. Provision is furthermore preferably made in accordance with the invention for the communication connections between at least some of the customer stations and the central units to be able to be set up via an existing telecommunications network.

Not only telephone landlines can be used for the setting up of the communication connections, but also in particular mobile radiotelephone networks.

A user can thereby, for example with the aid of his laptop, switch the heating of his house on or off or activate, deactivate or reprogram an automatic lighting system serving as a break-in protection during his absence from basically any location.

Generally any available communication connection can be used for the communication between the customer stations and the central units. Provision can thus be made for at least some of the communication connections to be able to be set up between the customer stations and the central units while utilizing the networks or protocols Datex-P, ISDN, DSL, UMTS, GSM, GPRS, EDGE, 3GSM, X.25, X.75, IP and/or TCP.

The hardware required at the customer side for the communication with the central units is hereby limited to the minimum anyway present in practically every household today.

A particularly high degree of flexibility is achieved when, in accordance with a further preferred embodiment of the invention, a number, and in particular a plurality, of customer terminals can be controlled simultaneously, alternatively either individually or group-wise, with one transmission request.

The central units are preferably each arranged in spatial proximity to their respective longwave transmitters. One central unit and the associated longwave transmitter jointly form one of the central longwave transmission devices, with the number of such longwave transmission devices generally being able to be any desired one in total within the radio ripple control system in accordance with the invention.

Provision is furthermore preferably made for at least one central monitoring unit to be provided with which communication connections can be set up with all central units. The monitoring unit is preferably spatially separate from the central units and the longwave transmitters.

The system can be monitored and serviced by means of the monitoring unit. It is furthermore possible to provide the monitoring unit for such processes as e.g. new customer registrations or changes to customer data which cannot or should not be made automatically by the central units alone. With respect to the customer stations, the monitoring unit is preferably in particular characterized by further reaching system authorizations.

As with one of the customer stations, a communication connection to any of the central stations can be established and e.g. the system status of the transmission device in question be checked from the monitoring unit. Irrespective of the number of longwave transmitters and central units, it can be sufficient for precisely one central control unit to be provided, with it, however, also being possible for a plurality of such monitoring units to be present—e.g. one at each important location of the system operator. The or each control unit can also be mobile in the sense that e.g. a laptop having corresponding monitoring software serves as the central monitoring unit.

In accordance with a further preferred embodiment of the invention, the transmission requests each include a pre-determinable transmission priority and/or a requested transmission time.

The customers can hereby determine themselves at which times specific control processes or switch processes should take place at their terminals. Provision can furthermore be made for the customers to fix the priorities of their transmission requests themselves, with different utilization charges being able to be incurred for different priorities. The customer can thus decide himself how much a prompt transmission or a transmission in exact accordance with the time request of the radio control telegrams initiated by him is worth.

Provision can alternatively or additionally be made for the transmission priority to be fixedly pre-set for every customer and for it not to be able to be changed by the customer. Private customers can e.g. thus generally be granted a lower priority than large customers such as energy supply corporations or municipal utility companies.

This prioritization of the transmission requests, which can generally take place independently of the actual technical performance capability of the radio ripple control system, advantageously provides the possibility of a direct grading, and in particular of a problem-free variable grading, of utilization charges.

In the radio ripple control system in accordance with the invention, provision can furthermore preferably be made for transmission requests which are incoming at the central units and have a pre-determined transmission priority to be able to be delayed in time.

Transmission requests can hereby also deliberately be delayed when the system or the relevant transmission device is not working at full capacity and the transmission request could also be carried out with immediate effect directly after arrival at the relevant central unit. This is in particular of advantage in connection with a system of utilization charges graded by different transmission priorities and makes a differentiated price policy and a corresponding marketing possible in this manner.

Utilization possibilities with a particularly large variety for the customers are provided if, in accordance with a further preferred embodiment of the invention, a one-time or a periodic transmission of radio control telegrams can optionally be initiated by means of the transmission requests. Preferably, In the case of a one-time transmission, an immediate transmission or a transmission taking place at a pre-determinable point in time can optionally be initiated.

The radio ripple control system in accordance with the invention is furthermore designed in a preferred embodiment such that successive radio ripple control telegrams of at least one longwave transmission device, and preferably of every central longwave transmission device, can be transmitted at a time interval of approximately 1 sec.

A particularly high-power system is hereby made available with which a large number of users or customers can also be served who are transmitting transmission wishes more or less simultaneously.

The terminals to be controlled can generally be any desired technical devices which can be switched on or off and/or can be programmed or parameterized. They can be complex units for tariff and load control in the sector of energy supply corporations or for the control of streetlights in the responsibility of municipal utilities.

The terminals can, however, also be technically simple apparatuses such as conventional socket boards via which electrical consumers present in private households can be switched on and off.

Every terminal is associated with a radio receiver which is in a position to receive the radio control telegrams transmitted by the longwave transmitters, to decode the information contained in the radio control telegrams and to convert this information or to transmit control signals to the terminals such that the desired control and/or switch processes can be triggered at the respective terminal.

The radio receivers can be integrated in the terminals. Alternatively, a spatially separate arrangement of radio receiver and terminal is possible. Furthermore, a plurality of terminals can be associated with one radio receiver in order thus to make possible a group-wise control of terminals. A group-wise control of terminals can alternatively also take place in that a separate radio receiver is associated with each terminal and all radio receivers are addressed simultaneously by corresponding radio control telegrams.

The selection of the required radio receivers preferably takes place by the user at the customer station by inputting the corresponding radio receiver addresses. A plurality of radio receivers can have the same address such that the user only has to input a single address for the simultaneous control of a plurality of radio receivers. This address is not checked by the relevant central unit, but the transmission of the radio control telegram containing the address takes place automatically—optionally after checking the authorization of the respective customer—by the central unit and by the respective longwave transmitter, whereby the plurality of radio receivers are addressed simultaneously.

The terminals can in particular be units freely available for the user commercially or through the operator of the radio ripple control system which can be purchased at prices also acceptable for private persons.

In a preferred embodiment of the invention, switch units with switching functions are provided as the controllable customer terminals, with the switch units preferably being able to be switched on and off by means of the radio control telegrams.

These are therefore such terminals which need a received radio control telegram at their radio receiver for a switching process.

The terminals do not have to be purely switch units to which one or more units can be connected, but technical domestic devices such as the house lighting, electric shutters, saunas or heating equipment can also be directly controlled via the radio receivers.

Furthermore, the control processes at the terminals which can be initiated by means of the transmission requests do not have to be pure switching processes. It is also possible to reprogram units remotely using the radio ripple control system in accordance with the invention which, for example, operate automatically and independently according to their own time switching scheme specific to the terminal, e.g. time switches for the house lighting, by transmission of a customer-initiated radio control telegram

Furthermore, lighting devices can be provided as controllable customer terminals such as streetlights, shop lighting, shop window lighting and advertising lights. Such applications are in particular interesting for commercial operators of food chains or drugstore chains.

Furthermore, equipment can also be controlled using the radio ripple control system in accordance with the invention which is important for the public community. For example, all siren equipment of a region or of a country can thus be activated by transmission of a single transmission request.

In a further improved embodiment of the invention, provision is made that equipment is provided as controllable customer terminals for the display or presentation, in particular the optical display or presentation, of information transmitted by means of the radio control telegrams

Such terminals can e.g. be price display devices in supermarkets. The supermarket operators can use the invention in the case of price changes simply to remark the products in question by initiating a corresponding transmission request. A further example for the transmission of information by means of the invention are the current waiting periods at stops of local public transport.

The possibility in accordance with the invention of transmitting displayable or presentable information optionally to basically any desired number of terminals or directly to a specific terminal with the aid of longwaves generally opens up a wide field of applications previously not realizable for a wide spectrum of customers.

A particular advantage of the radio ripple control system in accordance with the invention, above all for private users, is the use of longwaves for the control signal transmission, since there can practically be no reception difficulties for any installation location of the radio receivers due to their penetration capability. The radio receivers can thus be arranged without problem e.g. in cellar spaces and thus—for example, for the control of a heating plant or of a central control plant for a plurality of domestic technical devices—in direct proximity to the terminal to be controlled in each case.

In this respect, the radio control system in accordance with the invention based on longwaves provides substantial advantages with respect to the mobile radio technology which works with substantially shorter wave electromagnetic radiation.

A particularly simple and comparatively cost-favorable possibility for the transmission of transmission requests to the central units is provided in that, in accordance with a further preferred embodiment of the invention, PCs and/or laptops with software for the input and transmission of transmission requests are provided as customer stations.

The object underlying the invention is moreover satisfied by the features of the independent method claim and in particular in that the customerinitiated transmission requests are carried out automatically in that communication connections to the central units are set up at the customer stations and the transmission requests are transmitted to the central units, radio control telegrams corresponding to the transmission requests are transmitted in dependence on control commands automatically produced by means of the central units in accordance with the transmission requests and transmitted to the longwave transmitters and the customer terminals associated with the radio receivers are automatically controlled in accordance with the received radio control telegrams.

A particularly simple and customer-friendly operation of the radio control system in accordance with the invention results, in accordance with a particularly preferred embodiment, when the customer terminals to be controlled are selected at the customer stations and a communication connection is in each case set up automatically to the central unit associated with the radio receiver in dependence on the location of the respective radio receiver.

The customer consequently does not have to make any considerations as to which of the central units his terminal to be controlled is associated with in each case.

For this purpose, a radio receiver address is preferably associated with each radio receiver and is stored in the system so that by the selection of a radio receiver at a customer station it is automatically recognized with reference to the address to which central unit a communication connection has to be set up so that this central unit can control the longwave transmitter associated with it, via which the respective radio receiver can be reached, for the transmission of the radio control telegram corresponding to the transmission request.

Provision is furthermore preferably made in accordance with the invention for communication connections to be set up automatically to all central units associated with the respective radio receivers for transmission requests relating simultaneously to a plurality of customer terminals.

The user hereby also does not have to make any considerations of with how many and with which central units he must communicate so that his transmission request is carried out properly in cases in which the radio receivers belonging to his transmission request cannot be reached or—due to a permanent or temporary system operating state desired by the system operator—should not be reached by one single longwave transmitter alone.

In accordance with a further embodiment of the invention, provision is made for at least two longwave transmitters, in particular located at the same location, to be associated with at least one central unit and for radio control telegrams to be transmitted by them at different longwave frequencies simultaneously or offset in time in dependence on the transmission requests, with the transmission regions of the longwave transmitters preferably being substantially identical or overlapping one another at least to a large extent.

If one longwave transmitter and one longwave frequency used by this are termed a radio cell, then the possibility is provided by this embodiment of the invention to work with a plurality of radio cells for the customer-initiated control of customer terminals. Such longwave radio cells cannot be compared with a spatially closely restricted mobile radio cell since, in the radio ripple control system in accordance with the invention, all radio cells of a transmission device including a plurality of longwave receivers can cover the same transmission territory when the transmission territories of the longwave transmitters overlap one another 100%.

By the simultaneous or time-offset utilization of a plurality of such radio cells, a further differentiation possibility is advantageously provided and the flexibility and the capability of the system to react to the most varied customer requests is further increased.

If is furthermore possible in accordance with a further embodiment of the invention for radio control telegrams which agree in content to be transmitted at different longwave frequencies simultaneously or offset in time in dependence on the transmission requests.

The radio cells admittedly differ here with respect to the longwave frequencies used and/or to the longwave transmitters used for the transmission, but not with respect to the information transmitted to the radio receivers for the control of the terminals.

In accordance with a particularly preferred embodiment of the invention, a differentiation is made in the operation of the radio ripple control system between individual customers and large customers, with at least one system-inherent portal, in particular an Internet server, being made available to the individual customers and communication lines being made available to large customers for customer portals of their own, in particular for customer servers of their own.

The possibility hereby exists for large customers to offer radio ripple control services themselves and, more or less, to locate themselves on top of the radio ripple control system in accordance with the invention made available by the actual system operator such that the actual system operation is not recognizable for the end customer.

A particularly high reliability and precision of the radio ripple control in accordance with the invention is achieved when, in accordance with a preferred embodiment, the radio receivers are synchronized by means of the longwave transmitters in pre-settable time intervals with respect to a pre-determined time standard.

The reliability and thus the acceptance by the customer can be further increased if, in accordance with a particularly preferred embodiment, the transmitted radio control telegrams are checked as to their correct transmission and if a radio control telegram identified either as not transmitted at all or as transmitted incorrectly, is transmitted again at least once.

For this purpose, a monitoring radio receiver can be provided, for example at the location of each longwave transmitter, and can be connected to the respective central unit with whose aid the actually transmitted actual telegrams are compared with the desired telegrams corresponding to the customer requests.

Further embodiments of both the radio ripple control system in accordance with the invention and of the method in accordance with the invention for the operation of such a system are recited in the dependent claims in the description and in the drawing.

The invention will be described in the following by way of example with reference to the drawing whose single figure illustrates, purely schematically, the design and the functionality of a radio ripple control system in accordance with the invention.

The schematically represented radio ripple control system in accordance with the invention includes three longwave transmission devices 12 which each include a longwave transmitter 13, a central unit in the form of a redundant parallel computer system 15 as well as a monitoring radio receiver 37. The number of such transmission devices 12 is generally any desired in accordance with the invention and depends on the size of the transmission region to be covered. The frequencies used by the longwave transmitters 13 are preferably different from one another to avoid interference, in particular in overlapping areas of the transmission regions.

The stationing of the longwave transmitters 13 preferably takes place such that a reliable reception is possible at every point of the transmission territory to be covered, with range overlappings being as small as possible. To cover Germany, two longwave transmitters are, for example, sufficient which work in a frequency range from 70 to 150 kHz and which each have a range of several 100 kilometers around the transmitter location.

The transmission of the information corresponding to a specific transmission request to radio receivers 19 arranged decentrally in the reception region takes place by digital frequency modulation, digital amplitude modulation or other modulation methods of the longwave signal also termed a radio control telegram 23 and indicated in each case in the Figure as a jagged arrow.

The radio receivers 19 each have a decoder unit with which the information contained in the received longwave signal can be read. This information can only be utilized by those radio receivers 19 whose addresses are contained in the respective radio control telegram 23.

A plurality of radio receivers 19 can have the same address in order only to have to input a single radio receiver address on the initiating of a transmission request for the simultaneous control of these radio receivers 19.

The design and functionality of the central computers 15 and the purpose of the monitoring receiver 27 are described in more detail at a different point.

The radio ripple control system in accordance with the invention furthermore includes a plurality of decentralized or offset customer stations 17a, 17b, 17c. In the embodiment shown, a difference is made between different types of customer stations 17a, 17b, 17c, with the differences being due to the manner of the link to the central computers 15, to the properties and/or demands of the customers who utilize the stations 17a, 17b, 17c and to the motivation on the basis of which the customers respectively utilize the stations 17a, 17b, 17c and thus the ripple control in accordance with the invention. This will also be considered in more detail in the following.

The radio receivers 19 are each shown in the proximity to the relevant customer stations 17a, 17b, 17c in the Figure for the illustration of the organization of the radio ripple control system in accordance with the invention. It is made clear in the Figure by the jagged arrows directed toward the respective radio receivers 19 and representing the radio control telegrams 23 that the radio control telegrams 23 transmitted by the longwave transmitters 13 can be received by all the radio receivers 19 disposed in the respective transmission territory, provided that the radio control telegrams 23 contain the corresponding radio receiver address.

The radio ripple control system furthermore includes a single monitoring unit 27 which can communicate with each of the central computers 15.

The customer stations 17a, 17b, 17c and the control unit 27 are provided in the form of PCs or laptops and can agree in large parts with respect to the software running for the utilization of the ripple control system, with, however, a system monitoring, care and management being possible via the monitoring unit 27 which is closed to the customers using the normal customer stations 17a, 17b, 17c.

All functions which the customers can use from the customer stations 17a, 17b, 17c are preferably automatically taken over only by the central computers 15, i.e. the central monitoring station 27 is not required for the normal customer operation. In particular no communication connections are required for the normal operation between the customer stations 17a, 17b, 17c, on the one hand, and the monitoring station 27, on the other hand.

The communication connections 21 between the customer stations 17a, 17b, 17c and the monitoring unit 27, on the one hand, and the central computer 17, on the other hand, are indicated by double arrows in the Figure. With the exception of the customer stations 17a shown at the top left in the Figure, a communication connection 21 can be set up at every customer station 17b, 17c to each of the central units 15.

With the mentioned customer stations 17a communicating only with one of the central computers 15, it is not required or it is not wanted for system organizational reasons that communication also takes place with the other central units 15 and the representation of these customer stations 17a in the Figure should also illustrate the flexibility and the great variety of the ripple control system in accordance with the invention. These customer stations 17a communicating only with one central computer 15 can, for example, be fully functional old units whose conversion is not required or is not wanted. The communication between these customer stations 17a and the respective central computer 15 takes place via the Datex-P network (X.25).

In the customer stations 17c shown at the bottom right in the Figure, the set-up of the communication connections 21 to the individual central computers 15 takes place in each case while using the Internet 25. A system-inherent portal is made available for a customer circle, in particular formed by private customers, in the form of an Internet server 29 with which the customers can dial in via the normal landline telephone or a mobile radio network by means of their own PCs or laptops serving as a customer station 17c. The customers consequently only need an “Internet capable” computer 17c, but not any special software which only serves for the utilization of the radio ripple control system in accordance with the invention.

For anther customer circle formed in particular by large customers who in turn serve their own end customers and shown at the bottom left in the Figure, there is the possibility of being able to communicate with the central computers 15 of the radio ripple control system in accordance with the information via a portal 31 dedicated to big customers—in particular in the form of a server dedicated to big customers with which the end customers can in turn dial in via their own PCs or laptops 17b while using a normal telecommunications network 21 and/or a big customer network 35 operated or made available by the big customers themselves.

The actual operator of the ripple control system does not confront the end customer directly as the system operator, but the ripple control system is used by the big customers to themselves offer radio ripple control services for end customers.

The radio ripple control system in accordance with the invention is used by the customers to control their own terminals 11 in that, for example, processes for switching on or off are triggered or programming sessions or parameterization sessions can be carried out at the terminals 11.

A respective radio receiver 19 is associated either with each terminal 11 or with a group of terminals 11 and it receives radio control telegrams 23 transmitted by the longwave transmitters 13 and triggers the control processes on the basis of the information contained in these telegrams, whereby the transmission requests are carried out which were previously communicated to the central computers 15 via the customer stations 17a, 17b, 17c at the initiative of the customers.

Municipal utilities can thus, for example, switch streetlights on or off simply street-by-street, as is shown schematically at the top left in the Figure.

Commercial customers such as operators of store chains can automatically switch lighting devices on or off e.g. to illuminate shop windows simultaneously in all of their stores by means of the radio ripple control in accordance with the invention, as is indicated at the bottom left in the Figure.

The radio ripple control system in accordance with the invention provides private customers with the possibility of e.g. controlling domestic technical equipment 11 while utilizing the Internet 25, as is indicated at the bottom right in the Figure. For this purpose, it can be sufficient only to install a radio receiver 19 and to connect the terminal(s) 11 to be controlled to this radio receiver 19. Alternatively, a separate radio receiver 19 can be provided for each terminal 11 in the house.

The user can select all radio receivers 19 or individual radio receivers 19 directly with his PC or laptop 17c and transmit corresponding transmission requests to the respective central computer 15 via the Internet server 29 forming the system portal. It is not important whether the user is in the house or at another location, since the central computers 15 can be contacted from any desired location by the use of the Internet 25.

The design and operation of the radio ripple control system in accordance with the invention can take place, for example such as is described in the following.

The central units 15 are in each case a redundant computer system with a main computer and a parallel computer. Each of the two computers includes a physically independent functional unit having four main functions which are designated as a bus system, a control computer, a monitoring computer and a charge calculator, since the central computer 15 combines all these functions in it.

The bus system, or the corresponding functional section of the central computer 15, serves for the switching of the logical communication channels 21 between the offset customer stations 17a, 17b, 17c and the individual functional sections of the central computer 15 and between the individual functional sections of the central computer 15 among one another. Furthermore, the respectively current parameter record of the central computer 15 is guided by the bus system. The bus system function furthermore takes over control and monitoring functions for the central computer 15, detects inadmissible demand attempts and keeps a local operations diary.

The control computer, or the corresponding functional section of the central computer 15 provides the control of the respective longwave transmitter 13. The acceptance of the customer data packets, i.e. of the transmission requests with which the radio receiver 19 should be controlled or programmed, the transmission of the corresponding control commands 41 to the longwave transmitters 13 for the transmission of the radio control telegrams 23, the acceptance of parameterization instructions of the bus system function and the feedback of the system status, the detection of operating data and the keeping of a local operational diary take place by means of the control computer system.

The transmission operation is monitored by the monitoring computer, or by the corresponding functional section of the central computer 15, with the actual transmission operation being able to be reconstructed at a later point in time on the basis of the operating data detected by the monitoring computer function.

In particular the desired/actual comparison of the transmitted radio control telegrams 23, the monitoring of the operation status of the longwave transmitter 13, the detection of data relating to the actual transmission operation, the acceptance of parameterization instructions of the bus system function and the keeping of a local operations diary take place with the aid of the monitoring computer function.

The charge computer, or the corresponding functional section of the central computer 15, serves to monitor the transmission demands originating from the customer stations 17 and from the system's own central monitoring unit 27. In particular the billing data required for a correct billing are recorded. Furthermore, the charge computer function accepts parameterization instructions of the bus system function and keeps a local operations diary.

The central computers 15 of the radio ripple control system in accordance with the invention are in particular characterized by the use of a multitasking operating system with real time capability, whereby a particularly high time precision can be achieved on the transmission of the radio control telegram 23. Furthermore, every central computer 15 has an addressing volume of, for example, 64,000 single addresses, with the addressing volume generally being able to have any desired size in dependence on the number of the radio receivers 19 stationed in the reception region.

The customer stations 17a, 17b, 17c, or the software installed on the customer stations and/or on the central units, are designed such that the transmission of the radio control telegrams 23 takes place by means of a time list, with the radio control telegram database being scaleable. The customer stations 17a, 17b, 17c furthermore make a wide customer administration possible, monitor the system statuses, provide for a protocolling, have a web server functionality, serve as a communication interface to network guide systems and in particular allow a process coupling to analog or digital transducers via a correspondingly designed 10 interface.

The light conditions prevailing at the location of the lighting devices to be controlled—e.g. streetlights—can be detected by the transducers and transmitted to the respective customer station 17a, 17b, 17c at which a transmission request to switch the lighting devices on or off is automatically transmitted to the relative central computer(s) on the reaching of predetermined threshold-values.

Different access authorizations are distinguished with respect to the use or operation of the radio ripple control system in accordance with the invention. The customers of the system have access via the customer stations 17a, 17b, 17c to the query of the system status and to the transmission of transmission requests and thus to the programming of radio control telegrams. However, this only applies with respect to those application addresses which are released for the respective customer, with the release of the application addresses being reserved to the system operator.

The system operator or its system administrators have free access to all functions of the ripple control system, i.e. to the querying of the system status, to the programming of radio control telegrams 23 for all existing application addresses and to the actual administration, including the customer administration, via the central monitoring unit 27.

Furthermore, a service authorization is defined which only has access to the query of the system status. This service serves in particular for the alarm giving in the case of a malfunction occurring in the system.

The following safety precautions exist for the monitoring of the individual access authorizations by the system; on an access of the system via Datex-P (X.25), only the Datex-P address is required for a clear identification of the customer. The individual Datex-P addresses of the customers are administered by the system operator, with the Datex-P address of the system operator itself being able to be changed—and this is the preferred procedure—via the central monitoring unit 27 or by an on-site operation, i.e. at the location of the respective central computer 15.

The access authorization to all other communication connections 21 is ensured by a “LOGIN” and by the encoding of the communication (e.g. 128 bits), with the names, passwords and authorizations of the customers being stored in the central computers 15 and being able to be administered when required via the system's own monitoring unit 27.

On communication between the customer stations 17a, 17b, 17c and the control unit 27, on the one hand, and the central computers 15, on the other hand, the respective demands arriving at the central computers 15 are checked according to certain criteria and optionally rejected. In addition to the formal correctness, the demands must contain pre-determined authorizations and restrictions.

Demands which do not have the required authorization or which infringe the currently valid restrictions, are rejected with a corresponding error message. The central computer 15 keeps a protocol of inadmissible demand attempts.

Within the framework of the warranties given by the system operator to the customers, the central computers 15 must each be in a position to serve a plurality of customers, and thus a plurality of logical communication channels or communication connections 21 practically simultaneously. The “most critical” case is given for a central computer 15 when a plurality of, for example, 30 customers simultaneously transmit a transmission request of the highest priority and for the immediate, one-time transmission of a radio control telegram 23.

The central computers 15 are each designed such that such transmission requests are admittedly constantly accepted by the customer stations 17a, 17b, 17c, but are treated in accordance with a specific priority order. This priority order consists of transmission requests for the immediate, onetime transmission of a control telegram having a higher priority than all other transmission requests, with the treatment priority within these generally highest priority transmission requests being oriented on the respective transmission priorities contained in the individual transmission requests.

In connection with the programming of radio control telegrams 23 or the acceptance of the transmission wishes, the central computers 15 each take over the individual tasks named in the following. The memory locations provided for the individual transmission wishes are organized and administered. Furthermore, a monitoring takes place with respect to the admissibility of the transmission wishes, with feedback taking place to the respective customer station 17a, 17b, 17c both with respect to successful and rejected transmission requests.

The customer can choose from among different classes of transmission requests. Radio control telegrams 23 can thus be transmitted either (i) immediately and once; (ii) once and at a certain time; (iii) periodically monthly; (iv) periodically weekly; (v) periodically daily; or (vi) periodically hourly. Furthermore, (vii) an additional function is available which consists of, for example, transmitting an additional control telegram periodically, e.g. very 15 min., for test purposes. This additional function can be reserved to the system operator and can in this case only be selected via the system's own monitoring unit 27.

The memory location administration in the central computers 15 takes the specialties inherent in the individual transmission request classes into account. For example, a memory location for an immediate, one-time transmission only remains “busy” for a very short period of time. Memory locations for transmission requests with which the one-time transmission of a radio control telegram is requested at a specific time in each case become “free” again, when the respective point in time contained in the transmission request has been reached.

During operation, the central computers 15 each continuously monitor the transmission requests or demands for radio control telegrams 23 stored in the memory locations, with only the memory locations having the status “busy” being of interest. A transmission request or a demand becomes due when the date and time of the central computer 15 agree with the data describing the due time stored in the memory location.

Transmission wishes which have become due are transmitted in accordance with their priority into one of the provide priority buffers, with the priority buffers being of the FIFO buffer type.

Provision is made with respect to the control of the respective longwave transmitter 13 or of the interface to the longwave transmitter 13 for a new radio control telegram 23 to be made available by the central computer 15 for the transmission, i.e. the corresponding control commands 41 are transmitted to the longwave transmitter 13 as soon as a radio control telegram 23 has been transmitted. The waiting transmission request having the highest priority is removed from the priority buffers in each case and converted into control commands 41. The control commands 41 corresponding to the radio control telegram 23 to be transmitted are transmitted to the longwave transmitter 13 via an RS232 interface.

To synchronize the radio receivers 19 stationed in the reception region, the longwave transmitters 13 are caused by their central computers 15 to transmit so-called time telegrams at pre-defined time intervals.

As already mentioned in the introductory part of the description, the transmission of radio control telegrams 23 can be delayed by an adjustable time in dependence on the priority of the respective transmission requests. The length of the delay can be pre-determined in dependence on the individual priorities and/or in a customer specific manner or a customer class specific manner.

To ensure a high quality of the services provided by the system operator, a desired/actual comparison of the transmitted radio control telegrams 23 is provided. This desired/actual comparison serves in particular to compensate short-term malfunctions of the longwave transmitters 13 in that incorrectly transmitted radio control telegrams 23 are automatically recognized as such, on the one hand, and are transmitted again, on the other hand.

For this purpose, those control commands 41 (“desired”) transmitted in each case to the longwave transmitters 13 and corresponding to the underlying transmission request and, with the aid of the monitoring radio receiver 37, the radio control telegram 23 (“actual”) actually transmitted by the longwave transmitter 13 are detected by the central computers 15 in that a so-called actual telegram 39 is transmitted from the monitoring radio receiver 37 to the central computer 15.

These two signals are compared with one another bit-wise by the central computer 15. In the event of non-agreement, the control commands 41 corresponding to the desired radio control telegram 23 are again transmitted to the longwave transmitters 13. The number of the repeats of the same radio control telegrams 23 taking place as a maximum can generally be pre-set as desired.

### Reference Number List

11 customer terminal

12 transmission device

13 longwave transmitter

15 central unit, central computer

17a, 17b, 17c customer station

19 radio receiver

21 communication connection

23 radio control telegram

25 Internet

27 central monitoring unit

29 system's own portal

31 customer's own portal

35 customer network

37 monitoring radio receiver

39 actual telegram

41 control commands

1-33. (canceled)

34. A radio ripple control system for the control of a plurality of decentralized customer terminals (11) in dependence on customer-initiated transmission requests by means of central longwave transmission devices (12), comprising
at least two central longwaye transmitters (13) operable independently of one another;
at least two central units (15) which are each associated with one of the longwave transmitters (13) and which are designed in each case for the control of the transmission operation of at least one longwave transmitter (13) in dependence on the customer-initiated transmission requests;
a plurality of decentralized customer stations (17a, 17b, 17c) designed for the transmission of the customer-initiated transmission requests to the central units (15); and
a plurality of decentralized radio receivers (19) which are stationed in the reception region, with at least one customer terminal (11) to be controlled being associated with each of the decentralized radio receivers, each of which is associated with at least one of the central units (15) in dependence on its location,
wherein the respective transmission requests relating to at least one radio receiver (19) can automatically be transmitted to the corresponding central unit (15) via communication connections (21) which can be set up at the customer stations (17a, 17b, 17c); and wherein radio control telegrams (23) corresponding to the transmission requests can be transmitted automatically in dependence on control commands (41) generated by means of the control units (15) and transmitted to the longwave transmitters (13).

35. A system in accordance with claim 34, characterized in that the communication connections (21) can be set up between at least some of the customer stations (17a, 17b, 17c) and the central units (15) via the Internet (25).

36. A system in accordance with claim 34, characterized in that the communication connections (21) can be set up at least between some of the customer stations (17a, 17b, 17c) and the central units (15) via an existing telecommunications network, in particular via a telephone landline and/or a mobile radio network.

37. A system in accordance with claim 34, characterized in that at least some of the communication connections (21) between the customer stations (17a, 17b, 17c) and the central units (15) can be set up while using the networks or protocols Datex-P, ISDN, DSL, UMTS, GSM, GPRS, EDGE, 3GSM, X.25, X.75, IP and/or TCP.

38. A system in accordance with claim 34, characterized in that several customer terminals (11), and in particular a plurality of customer terminals (11), can be simultaneously controlled alternatively individually or group-wise with one transmission request.

39. A system in accordance with claim 34, characterized in that the central units (15) are arranged in spatial proximity to their respective longwave transmitter (13).

40. A system in accordance with claim 34, characterized in that at least one central monitoring unit (27) is provided with which communication connections (21) can be set up to all central units (15), with the monitoring unit (27) preferably being spatially separated from the central units (15) and from the longwave transmitters (13).

41. A system in accordance with claim 34, characterized in that the central units (15) each include a redundant computer system having a main computer and at least one parallel computer.

42. A system in accordance with claim 34, characterized in that the transmission requests each include a pre-settable transmission priority and/or desired transmission time.

43. A system in accordance with claim 42, characterized in that the transmission requests can automatically be brought by means of the central units (15) into a transmission order dependent on the transmission priorities and/or on the desired transmission times.

44. A system in accordance with claim 34, characterized in that transmission requests incoming at the central units (15) and having a pre-determined transmission priority can automatically be delayed in time.

45. A system in accordance with claim 34, characterized in that alternatively a one-time or periodic transmission of radio control telegrams (23) can be initiated by means of the transmission requests, with alternatively, preferably in the case of a one-time transmission, an immediate transmission or a transmission to a pre-settable time can be initiated.

46. A system in accordance with claim 34, characterized in that successive radio control telegrams (23) of at least one central longwave transmission device (12), and preferably of every central longwave transmission device (12), can be transmitted at a time interval of approximately 1 sec.

47. A system in accordance with claim 34, characterized in that switch devices with switching functions are provided as controllable customer terminals (11), with the switch devices preferably being able to be switched on and off by means of the radio control telegrams (23).

48. A system in accordance with claim 34, characterized in that domestic technical equipment is provided as the controllable customer terminals (11), in particular equipment in private households which can be switched, programmed and or parameterized.

49. A system in accordance with claim 34, characterized in that lighting equipment is provided as the controllable customer terminals (11), in particular streetlights, store lighting, shop window lighting and advertising lighting.

50. A system in accordance with claim 34, characterized in that optical and/or acoustic signal equipment is provided as the controllable customer terminals (11), in particular siren plants.

51. A system in accordance with claim 34, characterized in that equipment is provided as the controllable customer terminals (11) for the display or presentation, in particular the optical display or presentation, of information transmitted by means of the radio control telegrams (23).

52. A system in accordance with claim 34, characterized in that the customer stations (17a, 17b, 17c) include PCs and/or laptops with software for the input and transmission of transmission requests.

53. A system in accordance with claim 34, characterized in that it can be operated in accordance with a method in accordance with any one of the following claims.

54. A method for the operation of a radio ripple control system with which a plurality of decentralized customer terminals (11) can be controlled by means of central longwave transmission devices (12) in dependence on customer-initiated transmission requests and which comprises
at least two central longwave transmitters (13) operable independently of one another;
at least two central units (15) which are each associated with one of the longwave transmitters (13) and which are designed in each case for the control of the transmission operation of at least one longwave transmitter (13) in dependence on the customer-initiated transmission requests;
a plurality of decentralized customer stations (17a, 17b, 17c) designed for the transmission of the customer-initiated transmission requests to the central units (15); and
a plurality of decentralized radio receivers (19) which are stationed in the reception region, with each of which at least one customer terminal (11) to be controlled is associated,
wherein at least one of the central units (15) is associated with each radio receiver (19) in dependence on its location and the customer-initiated transmission requests are carried out automatically, in that
communication connections (21) can be set up to the central units (15) at the customer stations (17a, 17b, 17c) and the transmission requests are transmitted to the central units (15);
radio control telegrams (23) corresponding to the transmission requests are transmitted in dependence on control commands (41) generated automatically by means of the central units (15) in accordance with the transmission requests and transmitted to the longwave transmitters (13); and
the customer terminals (11) associated with the radio receivers (19) are controlled automatically in accordance with the received radio control telegrams (23).

55. A method in accordance with claim 54, characterized in that the customer terminals (11) to be controlled are selected at the customer stations (17a, 17b, 17c) and a communication connection (21) is set up automatically in each case to the central unit (15) associated with the radio receiver (19) in dependence on the location of the respective radio receiver (19).

56. A method in accordance with claim 54, characterized in that, with transmission requests relating to a plurality of customer terminals (11) simultaneously, communication connections (21) are automatically set up to all central units (15) associated with the respective radio receivers (19).

57. A method in accordance with claim 54, characterized in that at least two longwave transmitters (13), in particular located at the same place, are associated with at least one central unit (15) and with which radio control telegrams (23) are transmitted simultaneously or offset in time at different longwave frequencies in dependence on the transmission requests, with the transmission regions of the longwave transmitters (13) preferably being substantially identical or at least largely overlapping one another.

58. A method in accordance with claim 54, characterized in that radio control telegrams (23) which agree in content are transmitted simultaneously or offset in time at different longwave frequencies in dependence on the transmission requests.

59. A method in accordance with claim 54, characterized in that information is transmitted to the customer terminals (11) by means of the radio control telegrams (23) and the transmitted information is displayed or represented, in particular optically, at the customer terminals (11).

60. A method in accordance with claim 54, characterized in that differentiation is made between single customer and large customers, with at least one system-inherent portal (29), in particular an Internet server, being made available to the individual customers and communication links for customer's own portals (31), in particular for customer's own servers, being made available for large customers.

61. A method in accordance with claim 54, characterized in that the customer terminals (11) are programmed and/or parameterized by means of the radio control telegrams (23) with respect to an automatically running time switching scheme specific to the terminal.

62. A method in accordance with claim 54, characterized in that switching processes are triggered in the customer terminals (11) by means of the radio control telegrams (23).

63. A method in accordance with claim 54, characterized in that it is used for tariff and/or load control.

64. A method in accordance with claim 54, characterized in that the radio receivers (19) are synchronized with respect to a pre-determined time standard in pre-settable time intervals by means of the longwave transmitters (13).

65. A method in accordance with claim 54, characterized in that the transmitted radio telegrams (23) are checked, in particular by means of a monitoring radio receiver (37), as to their correct transmission and a radio control telegram (23) identified as not transmitted not at all or defectively is transmitted again at least once.

66. A method in accordance with claim 54, characterized in that a radio ripple control systems in accordance with any one of claims 1 to 19 is used.
